(19) United States
(12) Patent Application Publication
(10) Pub. No.: US 2015/0331543 A1
(43) Pub. Date: Nov. 19, 2015

(54) OPTICAL TOUCH MODULE

(71) Applicant: Quanta Computer Inc., Taoyuan Shien (TW)

(72) Inventor: Chien-Hung LIN, Taoyuan County (TW)

(73) Assignee: Quanta Computer Inc., Taoyuan Shien (TW)

(21) Appl. No.: 14/458,691

(22) Filed: Aug. 13, 2014

(30) Foreign Application Priority Data
May 15, 2014 (TW) 103117158

(51) Int. Cl. G06F 3/042; G06F 3/041; G06F 1/16

(52) U.S. Cl. CPC G06F 3/0421; G06F 1/16; G06F 3/0412; G06F 2203/04109

(57) ABSTRACT

An optical touch module is disposed on a display. The display has two edges opposite to each other and a plurality of corners. The optical touch module includes two frames, a plurality of light-emitting units, a plurality of sensors, and two retro-reflectors. The frames are respectively disposed on the opposite edges. The light-emitting units are respectively disposed on the frames and correspond to different corners. The sensors are respectively disposed adjacent to the light-emitting units. The retro-reflectors are respectively disposed on the frames and reflect light emitted by the light-emitting units, such that after the light is reflected, the light travels in the reversed original direction and is captured by the corresponding sensors.

### RELATED APPLICATIONS

This application claims priority to Taiwan Application Serial Number 103117158, filed May 15, 2014, which are herein incorporated by reference.

### BACKGROUND

In an optical touchscreen, the light sources and the receivers are disposed on the edges or the corners of the screen. The light sources emit light which is invisible to the naked eye, such as infrared ray, above the screen. When a user touches the screen by his finger, an infrared ray with a specified direction is blocked by the finger, in such a way that the infrared receiver would not receive the infrared ray with the specified direction. Therefore, the position where the finger touches the screen can be located after a manner of calculation.

In a conventional optical touchscreen, the receivers usually use a wide-angle camera lens to receive all signals distributed above the screen. However, the cost of a wide-angle camera lens is high, so the overall cost of an optical touchscreen may be high as well.

### SUMMARY

This disclosure provides an optical touch module.

In one aspect of the disclosure, an optical touch module is provided. The optical touch module is disposed on a display. The display has a first edge, a second edge opposite to the first edge, and a plurality of corners. The optical touch module includes a first frame, a second frame, a first light-emitting unit, a second light-emitting unit, a third light-emitting unit, a fourth light-emitting unit, a first sensor, a second sensor, a third sensor, a fourth sensor, a first retro-reflector, and a second retro-reflector. The first frame and the second frame are respectively disposed on the first edge and the second edge. The first light-emitting unit, the second light-emitting unit, the third light-emitting unit, and the fourth light-emitting unit respectively emit light. The first light-emitting unit and the second light-emitting unit are disposed on the first frame, and the third light-emitting unit and the fourth light-emitting unit are disposed on the second frame. Positions of the first light-emitting unit, the second light-emitting unit, the third light-emitting unit, and the fourth light-emitting unit respectively correspond to the corners. The first sensor, the second sensor, the third sensor, and the fourth sensor are respectively disposed adjacent to the first light-emitting unit, the second light-emitting unit, the third light-emitting unit, and the fourth light-emitting unit. The first retro-reflector is disposed on the first frame and reflects the light emitted by the third light-emitting unit and the fourth light-emitting unit, such that after the light is reflected, the light travels in the reversed original direction and is captured by the third sensor and the fourth sensor. The second retro-reflector is disposed on the second frame and reflects the light emitted by the first light-emitting unit and the second light-emitting unit, such that after the light is reflected, the light travels in the reversed original direction and is captured by the first sensor and the second sensor.

By the proper configuration of the optical touch module, the display surface of the display is divided into four regions. When an object touches any position of the display surface, coordinates of a touch point can be obtained by image information for calculation detected by only two of the four sensors. In addition, the detection of the touch point can be achieved when the detection range of the sensor encompasses the opposite retro-reflector, so the angle of the detection range of the sensor need not be large. Therefore, a wide-angle camera lens may not be needed, and the overall cost of the optical touch module can be reduced.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1A is a front view of an optical touch module and a display according to one embodiment of this invention;

FIG. 1B is a front view of the optical touch module of FIG. 1A disposed on the display;

FIG. 2A is a front view of the optical touch module of FIG. 1B with schematic optical paths;

FIG. 2B is a front view of the optical touch module of FIG. 1B with schematic reflected optical paths;

FIG. 3A shows images formed by sensors of FIG. 1B when there is no object on the display;

FIG. 3B shows images formed by the sensors of FIG. 1B when there is an object in a region A of the display;

FIG. 3C shows images formed by the sensors of FIG. 1B when there is an object in a region B of the display;

FIG. 3D shows images formed by the sensors of FIG. 1B when there is an object in a region C of the display;

FIG. 3E shows images formed by the sensors of FIG. 1B when there is an object in a region D of the display;

FIG. 4 is a schematic front view of the optical touch module of FIG. 1B when there is an object in the region A of the display;

FIG. 5A is a partial front view of the optical touch module of FIG. 1A; and

FIG. 5B is a side view of the optical touch module of FIG. 5A viewed along a direction V.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically depicted in order to simplify the drawings.

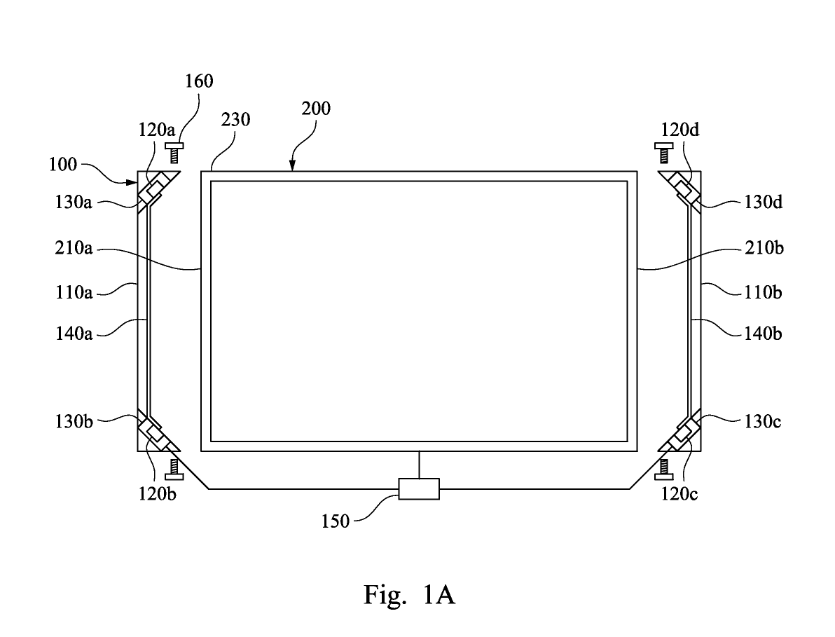

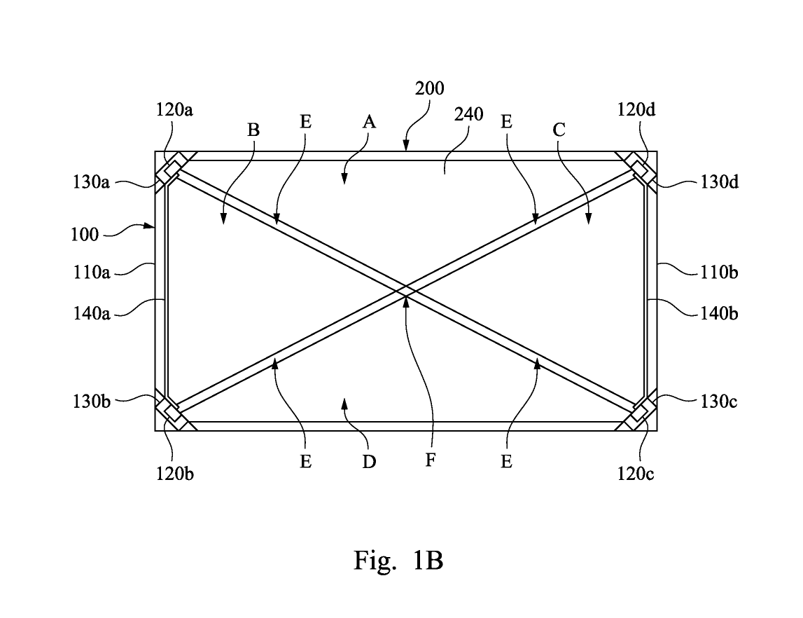

FIG. 1A is a front view of an optical touch module 100 and a display 200 according to one embodiment of this invention. FIG. 1B is a front view of the optical touch module 100 of FIG. 1A disposed on the display 200. As shown in FIG. 1A and FIG. 1B, an optical touch module 100 is provided. The optical touch module 100 can be disposed on a display 200, so that the display 200 has touch function.

The display 200 has a first edge 210a, a second edge 210b opposite to the first edge 210a, and a plurality of corners 230. The optical touch module 100 includes a first frame 110a, a second frame 110b, a first light-emitting unit 120a, a second light-emitting unit 120b, a third light-emitting unit 120c, a fourth light-emitting unit 120d, a first sensor 130a, a second sensor 130b, a third sensor 130c, a fourth sensor 130d, a first retro-reflector 140a, a second retro-reflector 140b, and a control unit 150.

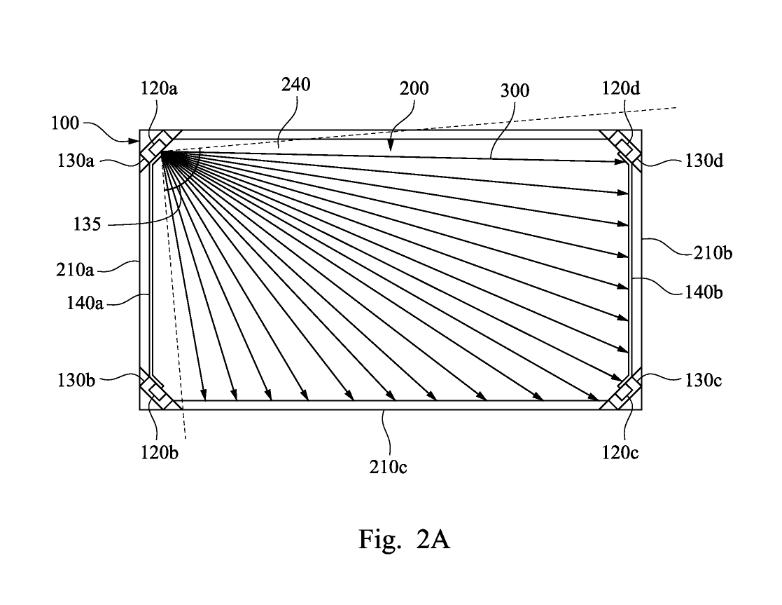

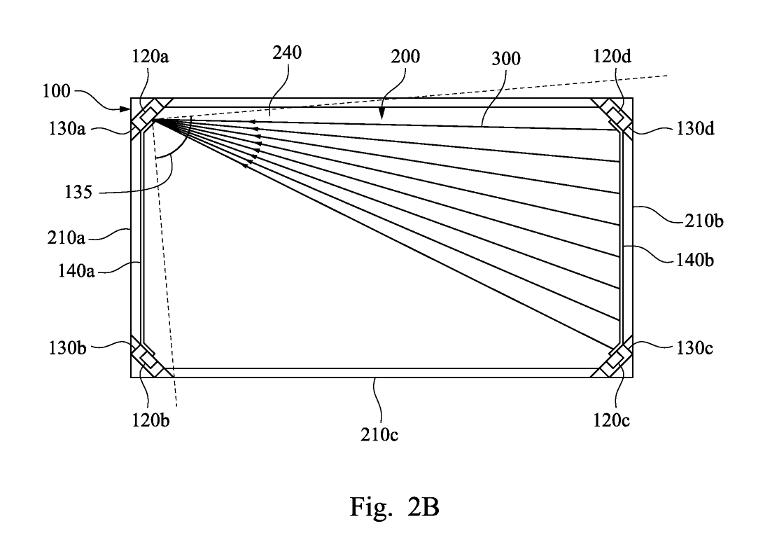

The first frame 110a and the second frame 110b are respectively disposed on the first edge 210a and the second edge 210b. The first light-emitting unit 120a, the second light-emitting unit 120b, the third light-emitting unit 120c, and the fourth light-emitting unit 120d respectively emit light 300 (shown in FIG. 2A and FIG. 2B). The first light-emitting unit 120a and the second light-emitting unit 120b are disposed on the first frame 110a, and the third light-emitting unit 120c and the fourth light-emitting unit 120d are disposed on the second frame 110b. Positions of the first light-emitting unit 120a, the second light-emitting unit 120b, the third light-emitting unit 120c, and the fourth light-emitting unit 120d respectively correspond to the corners 230. The first sensor 130a, the second sensor 130b, the third sensor 130c, and the fourth sensor 130d are respectively disposed adjacent to the first light-emitting unit 120a, the second light-emitting unit 120b, the third light-emitting unit 120c, and the fourth light-emitting unit 120d.

The first retro-reflector 140a is disposed on the first frame 110a and reflects the light 300 emitted by the third light-emitting unit 120c and the fourth light-emitting unit 120d, such that after the light 300 is reflected, the light 300 travels in the reversed original direction and is captured by the third sensor 130c and the fourth sensor 130d. The second retro-reflector 140b is disposed on the second frame 110b and reflects the light 300 emitted by the first light-emitting unit 120a and the second light-emitting unit 120b, such that after the light 300 is reflected, the light 300 travels in the reversed original direction and is captured by the first sensor 130a and the second sensor 130b.

The control unit 150 is electrically connected to the first light-emitting unit 120a, the second light-emitting unit 120b, the third light-emitting unit 120c, the fourth light-emitting unit 120d, the first sensor 130a, the second sensor 130b, the third sensor 130c, the fourth sensor 130d, and the display 200. The control unit 140 controls how the light-emitting units emit light and receives signals respective to the reflected light captured by the sensors to calculate coordinates of a touch point.

FIG. 2A is a front view of the optical touch module 100 of FIG. 1B with schematic optical paths. FIG. 2B is a front view of the optical touch module 100 of FIG. 1B with schematic reflected optical paths. As shown in FIG. 2A and FIG. 2B, the display 200 has a display surface 240, the first light-emitting unit 120a emits the light 300 above the display surface 240. Then, a part of the light 300 is reflected by the second retro-reflector 140b, and the light 300 travels in the reversed original direction and is captured by the first sensor 130a. The other part of the light 300 projected to a third edge 210c disposed between the first edge 210a and the second edge 210b is not reflected and does not travels in the reversed original direction because there is no reflector disposed on the third edge 210c. Optical paths of the other light-emitting units and the other sensors are similar to the above description and thus are not described in the following.

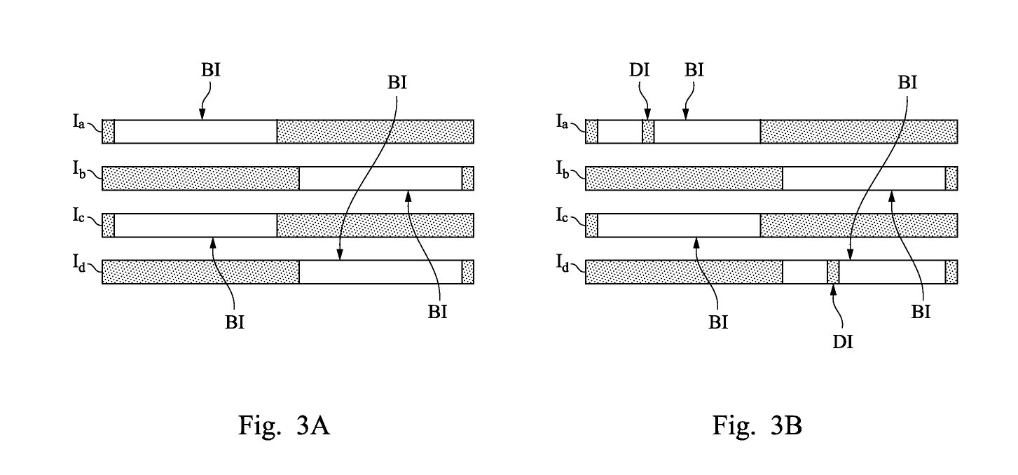

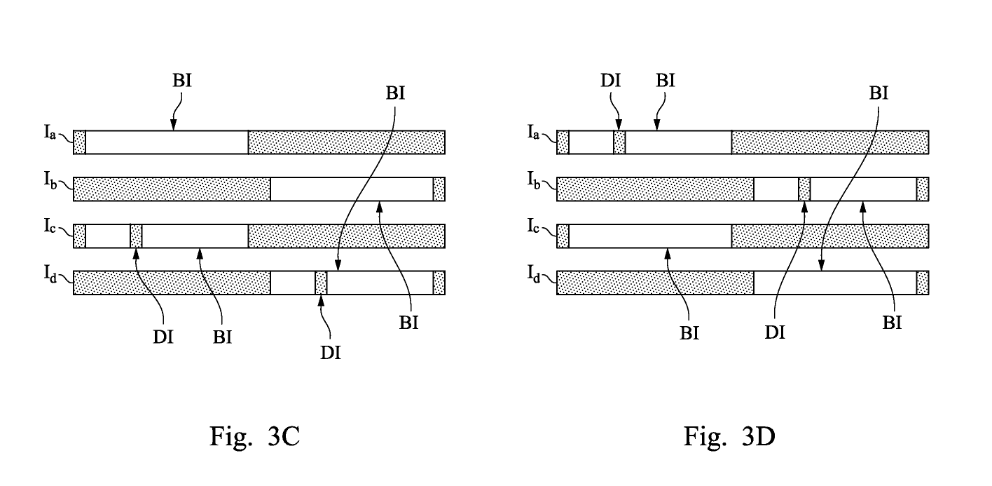

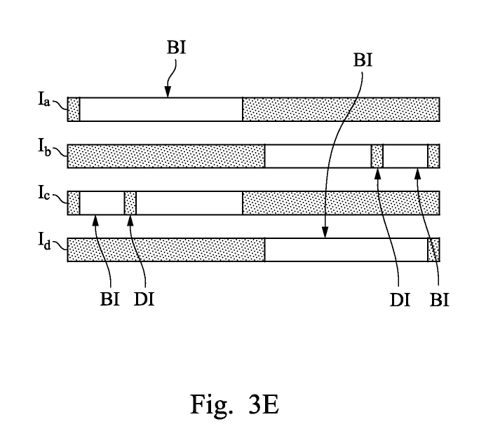

FIG. 3A shows images Iₐ, I_{b}, I_{c}, and I_{d} formed by sensors of FIG. 1B when there is no object on the display 200. As shown in FIG. 2A, FIG. 2B, and FIG. 3A, the first sensor 130a has a detection range 135, the detection range 135 encompasses the second retro-reflector 140b. Because the light 300 is reflected only in the range where the second retro-reflector 140b is disposed, the first sensor 130a detects the light 300 in only a part of the detection range 135 and forms an image Iₐ, in which a bright band BI is formed in a range of the image Iₐ corresponding to the range where the second retro-reflector 140b is disposed.

Similar to the above description, a detection range of the second sensor 130b encompasses the second retro-reflector 140b, and detection ranges of the third sensor 130c and the fourth sensor 130d encompass the first retro-reflector 140a. The second sensor 130b, the third sensor 130c, the fourth sensor 130d respectively form images I_{b}, I_{c}, and I_{d}, in which bright bands BI are formed in ranges of the image I_{b}, I_{c}, and I_{d}, corresponding to the ranges where the first retro-reflector 140a or the second retro-reflector 140b is disposed.

As shown in FIG. 1B, the display surface 240 can be divided by two diagonals into a region A disposed in the upper part of the display surface 240, a region B disposed in the left part of the display surface 240, a region C disposed in the right part of the display surface 240, and a region D disposed in the lower part of the display surface 240 (a region E disposed near the diagonals and a region F disposed near a center of the display surface 240 will be discussed later).

FIG. 3B shows images Iₐ, I_{b}, I_{c}, and I_{d} formed by the sensors of FIG. 1B when there is an object in the region A of the display 200. As shown in FIG. 1B, FIG. 2A, FIG. 2B, FIG. 3B, when an object (a finger, for example) touches a point in the region A, the object blocks a part of the light 300 emitted by the first light-emitting unit 120a in FIG. 2A, so the part of the light 300 does not reach the second retro-reflector 140b and is not reflected, such that the first sensor 130a does not capture the reflected light 300 in a range corresponding to the object. Therefore, a dark band DI is formed in a range of the image I, corresponding the range where the object is located (the bark band DI is formed in the bright band BI). Similarly, the object blocks the light 300 emitted by the fourth light-emitting unit 120d, so the fourth sensor 130d does not capture the reflected light 300 in a range corresponding to the object. Therefore, a dark band DI is formed in a range of the image I_{d} corresponding the range where the object is located. As for the second sensor 130b and the third sensor 130c, there is no reflector disposed on corresponding edges, so no matter whether there is an object in the region A, the images I_{b} and I_{c} formed by the second sensor 130b and the third sensor 130c are the same (as shown in FIG. 3A and FIG. 3B). In other words, only the images Iₐ and I_{d} are used to determine whether there is an object in the region A, and the images I_{b} and I_{c} are not used to determine whether there is an object in the region A.

FIG. 3C shows images Iₐ, I_{b}, I_{c}, and I_{d} formed by the sensors of FIG. 1B when there is an object in the region B of the display 200. FIG. 3D shows images Iₐ, I_{b}, I_{c}, and I_{d} formed by the sensors of FIG. 1B when there is an object in the region C of the display 200. FIG. 3E shows images Iₐ, I_{b}, I_{c}, and I_{d} formed by the sensors of FIG. 1B when there is an object in the region D of the display 200. As shown in FIG. 1B, FIG. 3C, FIG. 3D, and FIG. 3E, similar to the above description, when an object touches a point in the region B, C, or D, the object blocks a part of the light 300 emitted by two light-emitting unit, and dark bands DI are formed in the images formed by the corresponding sensors.

As long as an object touches a point in the region A, B, C, or D, dark bands are formed in two of the images, and the other two of the images do not change. Therefore, the control unit 150 can know which region the touch point is located by knowing that which two images dark bands are formed in, and the position of the touch point can be further calculated. The detailed information is described in the following.

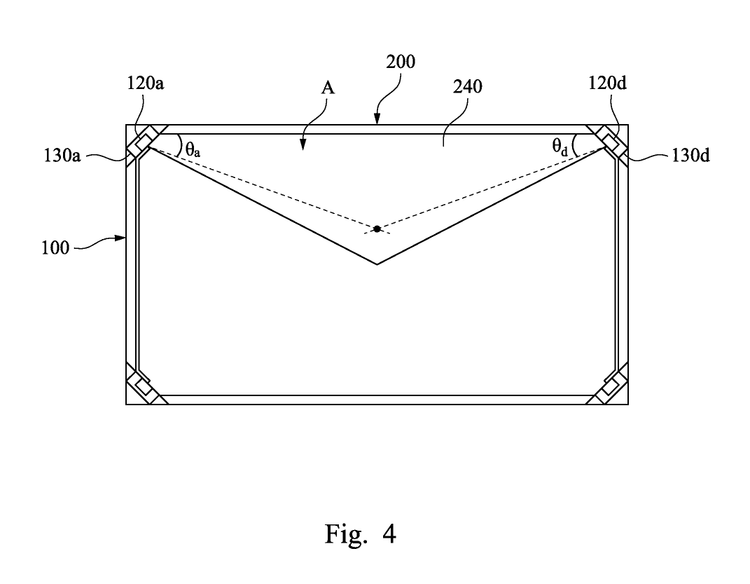

FIG. 4 is a schematic front view of the optical touch module 100 of FIG. 1B when there is an object in the region A of the display 200. As shown in FIG. 3B and FIG. 4, when an object touches a touch point X, a dark band DI is formed in a range of the image Iₐ corresponding to the range where the object is located, and an angle θₐ between a line connecting the first sensor 130a and the fourth sensor 130d and a line connecting the first sensor 130a and the touch point X can be known by analyzing the position of the dark band DI in the image Iₐ. Similarly, an angle θ_{d} between a line connecting the first sensor 130a and the fourth sensor 130d and a line connecting the fourth sensor 130d and the touch point X can be known by analyzing the position of the dark band DI in the image I_{d}. Then, by trigonometry calculation or simultaneous point-slope equations combined with the given coordinates of the first sensor 130a and the fourth sensor 130d, the coordinates of the touch point X can be obtained, so as to achieve detection of the appropriate location.

Similar to the above description, when an object touches a point in the region B, C, or D, the associated angle information can be known by analyzing the positions of the dark bands DI in the images Iₐ, I_{b}, I_{c}, and I_{d}. Then, by trigonometry calculation or simultaneous point-slope equations combined with the given coordinates of the sensors, the coordinates of the touch point can be obtained.

From the above description, the display surface 240 is divided into four regions. When an object touches any region of the display surface 240, the coordinates of the touch point can be known if two of the four sensors detect image information for calculation. In addition, the detection of the touch point can be achieved when the detection range of the sensor encompasses the opposite retro-reflector, so the angle of the detection range of the sensor need not be large. Therefore, a wide-angle camera lens may not be needed, and the overall cost of the optical touch module 100 can be reduced.

In one embodiment, the angles of detection ranges of the first sensor 130a, the second sensor 130b, the third sensor 130c, and the fourth sensor 130d are smaller than 90 degrees. Or, the angles of detection ranges of the first sensor 130a, the second sensor 130b, the third sensor 130c, and the fourth sensor 130d are in a range from about 45 degrees to about 60 degrees.

The first frame 110a and the second frame 110b are respectively fixed to the display 200 via screws 160 or adhesives. People having ordinary skill in the art can make proper modification to the fixing method of the first frame 110a and the second frame 110b according to their actual needs.

Lengths of the first frame 110a and the second frame 110b are adjustable, such that the lengths of the first frame 110a and the second frame 110b respectively correspond to lengths of the first edge 210a and the second edge 210b. In practical operation, the lengths of the first frame 110a and the second frame 110b are adjusted to respectively correspond to the lengths of the first edge 210a and the second edge 210b, and then the first retro-reflector 140a and the second retro-reflector 140b with lengths respectively corresponding to the lengths of the first edge 210a and the second edge 210b are fixed to the first frame 110a and the second frame 110b.

Specifically, the first edge 210a and the second edge 210b of FIG. 1A respectively are a left edge and a right edge of the display 200. In other embodiments, the first edge 210a and the second edge 210b may respectively be a top edge and a bottom edge of the display 200.

In one embodiment, the light emitted by the first light-emitting unit 120a, the second light-emitting unit 120b, the third light-emitting unit 120c, and the fourth light-emitting unit 120d is infrared light, and the first sensor 130a, the second sensor 130b, the third sensor 130c, and the fourth sensor 130d are infrared light sensors.

Before the optical touch module 100 disposed on the display 200 is used, the optical touch module 100 should be corrected. The correction method is displaying a plurality of correction point with known associated angle information on the display surface 240, for being touched by a user. When the user touches the correction points, the positions of the dark bands DI located in the bright bands BI in the images Iₐ, I_{b}, I_{c}, and I_{d} can rightly correspond to the associated angle information because the associated angle information is known. In addition, the correction points can all be located in the same line parallel to the first edge 210a and the second edge 210b.

As shown in FIG. 1B, when an object touches a touch point in the region E disposed near the diagonals, a situation that three sensors detect the object may happen due to a system error. As described above, when each sensor detects a touch point, an associated angle information can be known, and a line connecting the touch point and the sensor can be obtained by the associated angle information combined with the given coordinates of the sensor. When the object is detected by only two sensors, the intersection of the two lines is the touch point. However, when the object is detected by three sensors, the three lines may intersect at one point or three points. When the three lines intersect at one point, the point is recognized as the touch point. When the three lines intersect at three points, a barycenter of the three points is recognized as the touch point.

Similarly, when an object touches a touch point in the region F disposed near a center of the display surface 240, a situation in which four sensors detect the object may happen, and four lines connecting the touch point and the sensors can be obtained. When the four lines intersect at one point, the point is recognized as the touch point. When the four lines intersect at four points, a barycenter of the four points is recognized as the touch point.

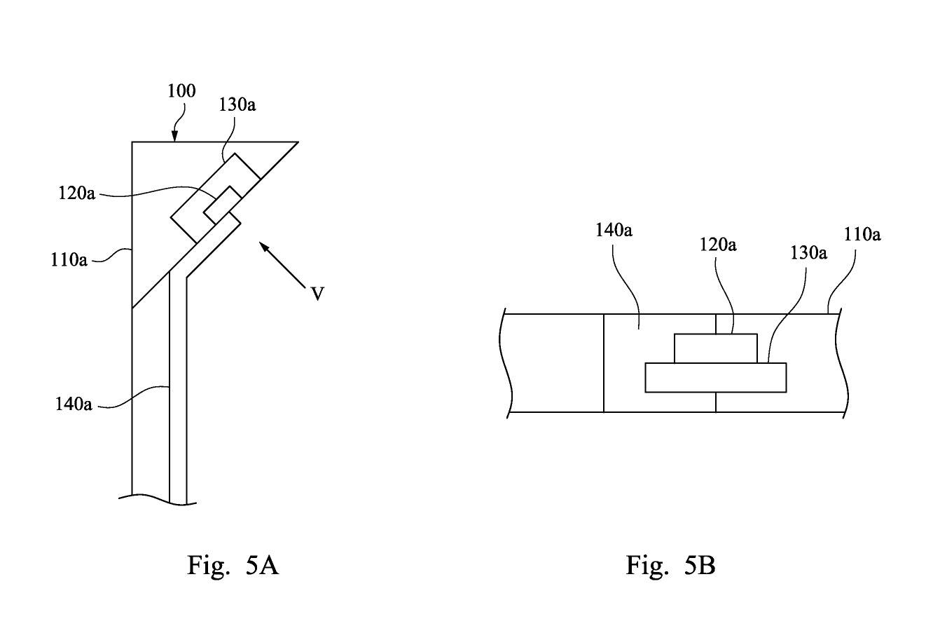

FIG. 5A is a partial front view of the optical touch module 100 of FIG. 1A. FIG. 5B is a side view of the optical touch module 100 of FIG. 5A viewed along a direction V. As shown in FIG. 1A, FIG. 5A, and FIG. 5B, one end of the first retro-reflector 140a extends to a central axis of the first sensor 130a, i.e., one end of the first retro-reflector 140a extends to one corner 230 connected to the first edge 210a. As shown in FIG. 1A, another end of the first retro-reflector 140a extends to a central axis of the second sensor 130b, i.e., another end of the first retro-reflector 140a extends to another corner 230 connected to the first edge 210a. Therefore, two ends of the first retro-reflector 140a respectively extend to the central axes of the first sensor 130a and the second sensor 130b, and two ends of the first retro-reflector 140a respectively extend to the corners 230 connected to the first edge 210a.

The depositions of the second retro-reflector 140b is similar to that of the first retro-reflector 140a, i.e., two ends of the second retro-reflector 140b respectively extend to central axes of the third sensor 130c and the fourth sensor 130d, and two ends of the second retro-reflector 140b respectively extend to the corners 230 connected to the second edge 210b.

As shown in FIG. 1B, by the above deposition, even when the light-emitting unit emits light in a direction along a diagonal of the display surface 240, the light is reflected by the corresponding retro-reflector and captured by the corresponding sensors. Therefore, a touch point located at any position of the display surface 240 can be detected. Even when an object touches a point in the region E or F, the optical touch module 100 can still obtain the coordinates of the touch point.

By the proper configuration of the optical touch module 100, the display surface 240 of the display 200 is divided into four regions. When an object touches any position of the display surface 240, the coordinates of the touch point can be obtained by the image information for calculation detected by only two of the four sensors. In addition, the detection of the touch point can be achieved when the detection range of the sensor encompasses the opposite retro-reflector, so the angle of the detection range of the sensor needs not be large. Therefore, wide-angle camera lens may not be needed, and the overall cost of the optical touch module 100 can be reduced.

All the features disclosed in this specification (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

What is claimed is:

1. An optical touch module disposed on a display, wherein the display has a first edge, a second edge opposite to the first edge, and a plurality of corners, the optical touch module comprising:
a first frame and a second frame respectively disposed on the first edge and the second edge;
a first light-emitting unit, a second light-emitting unit, a third light-emitting unit, and a fourth light-emitting unit, for respectively emitting light, wherein the first light-emitting unit and the second light-emitting unit are disposed on the first frame, the third light-emitting unit and the fourth light-emitting unit are disposed on the second frame, and positions of the first light-emitting unit, the second light-emitting unit, the third light-emitting unit, and the fourth light-emitting unit respectively correspond to the corners;
a first sensor, a second sensor, a third sensor, and a fourth sensor respectively disposed adjacent to the first light-emitting unit, the second light-emitting unit, the third light-emitting unit, and the fourth light-emitting unit;
a first retro-reflector disposed on the first frame, for reflecting the light emitted by the third light-emitting unit and the fourth light-emitting unit, such that after the light is reflected, the light travels in the reversed original direction and is captured by the third sensor and the fourth sensor; and
a second retro-reflector disposed on the second frame, for reflecting the light emitted by the first light-emitting unit and the second light-emitting unit, such that after the light is reflected, the light travels in the reversed original direction and is captured by the first sensor and the second sensor.

2. The optical touch module of claim 1, wherein detection ranges of the first sensor and the second sensor encompass the second retro-reflector, and detection ranges of the third sensor and the fourth sensor encompass the first retro-reflector.

3. The optical touch module of claim 1, wherein the angles of the detection ranges of the first sensor, the second sensor, the third sensor, and the fourth sensor are smaller than 90 degrees.

4. The optical touch module of claim 1, wherein angles of detection ranges of the first sensor, the second sensor, the third sensor, and the fourth sensor are in a range from about 45 degrees to about 60 degrees.

5. The optical touch module of claim 1, wherein lengths of the first frame and the second frame are adjustable, such that the lengths of the first frame and the second frame respectively correspond to lengths of the first edge and the second edge.

6. The optical touch module of claim 1, wherein the first frame and the second frame are respectively fixed to the display via screws or adhesives.

7. The optical touch module of claim 1, wherein the light emitted by the first light-emitting unit, the second light-emitting unit, the third light-emitting unit, and the fourth light-emitting unit is infrared light, and the first sensor, the second sensor, the third sensor, and the fourth sensor are infrared light sensors.

8. The optical touch module of claim 1, wherein the first edge and the second edge respectively are a left edge and a right edge/a top edge and a bottom edge of the display.

9. The optical touch module of claim 1, wherein two ends of the first retro-reflector respectively extend to the corners connected to the first edge, and two ends of the second retro-reflector respectively extend to the corners connected to the second edge.

10. The optical touch module of claim 1, wherein two ends of the first retro-reflector respectively extend to central axes of the first sensor and the second sensor, and two ends of the second retro-reflector respectively extend to central axes of the third sensor and the fourth sensor.
